(19) United States
(12) Patent Application Publication
(10) Pub. No.: US 2024/0332499 A1
(43) Pub. Date: Oct. 3, 2024

(54) ELECTRODE, SECONDARY BATTERY, BATTERY PACK, AND VEHICLE

(71) Applicant: Kabushiki Kaisha Toshiba, Tokyo (JP)

(72) Inventors: Tomoko SUGIZAKI, Kawasaki (JP); Hirofumi YASUMIISHI, Kawasaki (JP); Tomoe KUSAMA, Bunkyo (JP); Tetsuya SASAKAWA, Yokohama (JP)

(73) Assignee: Kabushiki Kaisha Toshiba, Tokyo (JP)

(21) Appl. No.: 18/433,769

(22) Filed: Feb. 6, 2024

(30) Foreign Application Priority Data
Mar. 27, 2023 (JP) 2023-049783

(51) Int. Cl. H01M 4/36; B60L 7/10; B60L 50/60; H01M 4/02; H01M 4/485; H01M 4/587; H01M 50/211; H01M 50/574

(52) U.S. Cl. CPC H01M 4/364; H01M 4/485; H01M 4/587; H01M 50/211; H01M 50/574; B60L 7/10; B60L 50/60; H01M 2004/021; H01M 2220/20

(57) ABSTRACT

An electrode includes an active material-containing layer. The active material-containing layer includes an active material containing a titanium-containing composite oxide, and carbon fiber. The active material-containing layer has a peak indicating a maximum logarithmic differential pore volume, in a logarithmic differential pore volume distribution curve by mercury porosimetry. A pore diameter PD at the peak is greater than 0.1 μm and 0.3 μm or less.

### CROSS-REFERENCE TO RELATED APPLICATIONS

This application is based upon and claims the benefit of priority from Japanese Patent Application No. 2023-049783 filed on Mar. 27, 2023, and the entire contents of which are incorporated herein by reference.

### FIELD

Embodiments described herein relate generally to an electrode, a secondary battery, a battery pack, and a vehicle.

### BACKGROUND

A lithium ion secondary battery such as a non-aqueous electrolyte secondary battery is a rechargeable battery in which charge and discharge is performed by the movement of lithium ions between a positive electrode and a negative electrode.

The positive electrode and the negative electrode retain a non-aqueous electrolyte containing lithium ions.

The non-aqueous electrolyte secondary battery is expected to be used not only as a power source for a small electronic device but also as a medium or large power source such as in-vehicle use or stationary use, and is required to improve high-temperature cyclic performance.

### BRIEF DESCRIPTION OF THE DRAWINGS

FIG. 1 is an example of an active material-containing layer of an electrode;

FIG. 2 is an example of a logarithmic differential pore volume distribution curve of the active material-containing layer by mercury porosimetry;

FIG. 3 is an example of a secondary battery;

FIG. 4 is a sectional view in which a part A of the secondary battery illustrated in FIG. 3 is enlarged;

FIG. 5 is a partial cutout perspective view schematically illustrating another example of the secondary battery;

FIG. 6 is a sectional view in which a part B of the secondary battery illustrated in FIG. 5 is enlarged;

FIG. 7 is a perspective view schematically illustrating an example of an assembled battery;

FIG. 8 is an exploded perspective view schematically illustrating an example of a battery pack;

FIG. 9 is a block diagram illustrating an example of an electric circuit of the battery pack;

FIG. 10 is a partial transparent view schematically illustrating an example of a vehicle;

FIG. 11 is a diagram schematically illustrating an example of a control system relevant to an electric system in the vehicle; and

FIG. 12 is a relationship between a peak pore diameter PD and a total pore volume TA.

### DETAILED DESCRIPTION

Hereinafter, embodiments for carrying out the invention will be described with reference to the drawings. The embodiments do not limit the present invention.

The same parts in the drawings are denoted by the same reference numerals, detailed description thereof will be omitted as appropriate, and different parts will be described.

Note that the drawings are schematic or conceptual, and the relationship between the thickness and the width of each part, the ratio of the sizes between parts, and the like are not necessarily the same as actual ones.

Even in a case of representing the same part, dimensions and ratios may be represented differently from each other depending on the drawings.

### First Embodiment

According to this embodiment, an electrode is provided. The electrode includes an active material-containing layer. The active material-containing layer contains an active material and carbon fiber. The active material contains a titanium-containing composite oxide.

In the active material-containing layer of the electrode according to the embodiment, the active material and the carbon fiber are mixed. Then, the carbon fiber is capable of forming a conductive path over a long distance, compared to granular carbon. Therefore, in the active material-containing layer of the electrode according to the embodiment, even in a case where there is a volume change in the active material, the conductive path between the active materials is less likely to be destroyed.

In addition, the electrode according to the embodiment contains the active material-containing layer in which a pore diameter PD of a peak indicating maximum height, that is, a mode diameter is large enough to retain an electrolyte, and a full width at half height of the peak is comparatively small. Accordingly, it can be said that the active material-containing layer has a pore distribution in which pores that are large enough to retain the electrolyte are comparatively evenly distributed. Therefore, it can be said that the electrolyte is evenly retained in the active material-containing layer.

From the above, the electrode according to the embodiment is capable of attaining excellent cyclic performance even in a high-temperature environment. Hereinafter, in this specification, the cyclic performance in the high-temperature environment may be expressed as “high-temperature cyclic performance”.

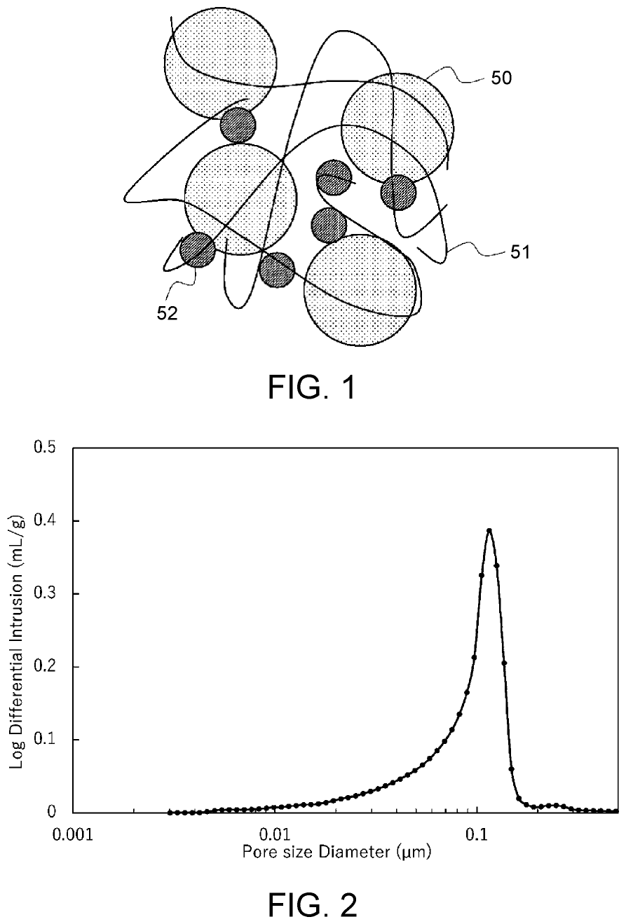

FIG. 1 is a schematic view illustrating an example of the active material-containing layer of the electrode according to the embodiment. The active material-containing layer illustrated in FIG. 1 includes active material particles 50, carbon fiber 51, and granular carbon 52. The active material particles 50 and the granular carbon 52 are in contact with the elongated string-shaped carbon fiber 51. The carbon fiber 51 and the granular carbon 52 form a conductive path. The granular carbon 52 is between the active material particles 50. The carbon fiber 51 can be between the active material particles 50 that are away from each other. Each gap between active material particles 50 and the granular carbons 52 can be impregnated with the electrolyte, which is not illustrated. Note that, the granular carbon 52 may be omitted. In the active material-containing layer illustrated in FIG. 1, even in a case where the granular carbon 52 is omitted, the conductive path by the carbon fiber 51 is maintained.

FIG. 2 is a graph illustrating an example of a logarithmic differential pore volume distribution curve (log differential pore volume distribution curve) of the active material-containing layer of the electrode according to the embodiment by mercury porosimetry. In the graph of FIG. 2, a vertical axis is a logarithmic differential pore volume, and a horizontal axis is a pore diameter. The active material-containing layer of the electrode according to this embodiment exhibits a peak indicating the maximum logarithmic differential pore volume, in the logarithmic differential pore volume distribution curve by mercury porosimetry. A pore diameter PD of the peak is greater than 0.1 μm and 0.3 μm or less. The pore diameter PD of the peak, that is, mode diameter is the diameter size of the pore with the highest existence ratio, among a plurality of pores provided in the active material-containing layer. In a case where PD is in such a range, a sufficient electrolyte can be retained in the active material-containing layer. In a case where PD is sufficiently large, the electrode is easily impregnated with an electrolytic solution even in a high-temperature condition, and the drying of the solution in a high-temperature cycle can be suppressed. On the other hand, in a case where PD is excessively large, the strength of the electrode is weakened, and the cyclic performance is degraded. Accordingly, it is preferable that PD is greater than 0.1 μm and 0.3 μm or less. The logarithmic differential pore volume distribution curve of the active material-containing layer is obtained by the following method. The graph illustrated in FIG. 2 is according to Example 1 described below. In the graph of FIG. 2, PD is 0.12 μm.

The full width at half height of the peak is 0.1 μm or less. A small full width at half height of the peak indicates that the pores provided in the active material-containing layer are even in size. In a case where the pores provided in the active material-containing layer are even in size, the electrolyte is evenly retained in the active material-containing layer, and a reaction between the active material and the electrolyte is more likely to evenly occur. The lower limit value of the full width at half height of the peak is not particularly limited, and for example, is 0.01 μm or more. The full width at half height of the peak is preferably 0.06 μm or less, and more preferably 0.05 μm or less. In the graph of FIG. 2, the full width at half height is 0.04 μm.

The logarithmic differential pore volume distribution curve and a cumulative pore volume distribution curve of the active material-containing layer by mercury porosimetry, for example, are obtained by the following method. First, in a case where the electrode is included in a secondary battery, the secondary battery is set in a discharge state, and then, is disassembled to extract the electrode. Such disassembly is performed in a glove box in an inert gas atmosphere such as argon. The discharge state refers to a state where the battery is discharged until the charging rate is 0%. The extracted electrode is washed with a solvent, and then, dried. As the solvent, for example, ethyl methyl carbonate is used. The dried electrode is cut to obtain a plurality of test pieces. The size of the test piece has, for example, belt shape having a short side of 1.25 cm and a long side of 2.5 cm.

Next, a plurality of test pieces is placed in a measurement cell of a measuring device and mercury is forced to introduce into pores of the test pieces. The number of test pieces is set, for example, to 16 or more and 32 or less. As the measurement cell, for example, a 5 cc-cell for large pieces having a stem volume of 0.4 cc is used. As the measuring device, for example, SHIMADZU Autopore 9520 (Autopore 9520 model manufactured by SHIMADZU CORPORATION) is used. In the measurement, for example, an initial pressure is set to 7 kPa, and an end pressure is set to 414 MPa. 7 kPa corresponds to 1.0 psia (pound per square inch absolute) and corresponds to a pore of a diameter of about 180 μm. 414 MPa corresponds to about 6 psia and corresponds to a pore of a diameter of about 0.003 μm. A mercury contact angle is set to 130 degrees, and a mercury surface tension is set to 485 dynes/cm. By processing the obtained data, it is possible to obtain the logarithmic differential pore volume distribution curve, the cumulative pore volume distribution curve, the total pore surface area, and the total pore volume of the active material-containing layer.

It is preferable that a total pore surface area TA of the active material-containing layer by mercury porosimetry is 4 m²/g or more. In a case where TA is large, it can be said that a plurality of fine pores is provided in the active material-containing layer. The upper limit value of the size of TA is not particularly limited, and for example, is 8 m²/g or less. TA is preferably 5 m²/g or more, and more preferably 6 m²/g or more.

It is preferable that a total pore volume TV of the active material-containing layer by mercury porosimetry is 0.15 mL/g or less. In a case where TV is small, it can be said that there are few voids in the active material-containing layer. By using the electrode including such an active material-containing layer, an energy density of the secondary battery can be increased. On the other hand, it is preferable that TV is 0.04 mL/g or more, from the viewpoint of increasing the amount of electrolyte retained in the active material-containing layer. It is more preferable that TV is 0.05 mL/g or more and 0.15 mL/g or less, from the viewpoint that the energy density is high, and a sufficient electrolyte can be retained.

It is preferable that a value MD-PD obtained by subtracting the pore diameter PD of the peak from a median diameter MD of the active material-containing layer by mercury porosimetry is −0.02 μm or more and 0.02 μm or less. MD of the active material-containing layer is a pore diameter when a cumulative volume is 50%, in the cumulative pore volume distribution curve of the active material-containing layer by mercury porosimetry. In a case where the value MD-PD is in such a range, it can be said that PD and MD are approximately identical to each other. It can be said that such an active material-containing layer has pores of which diameters are less variable. It is more preferable that the value MD-PD is −0.01 μm or more and 0.01 μm or less.

It is preferable that a relationship between the total pore surface area TA and the pore diameter PD of the peak of the active material-containing layer by the mercury intrusion technique is represented by Expression (1) described below.

$$TA = a \times PD + b \qquad ( 1 )$$

Here, a in the expression is a=−−17, and b in the expression is 7≤b≤10.6. The active material-containing layer in which the relationship between TA and PD is in such a range is less likely to cause a deterioration due to a side reaction. Since the electrolytic solution retainability of the electrode becomes higher as TA increases, the drying of the solution in a high-temperature cycle is less likely to occur, but in a case where the size of TA is a threshold value or more, a side reaction accompanied by gas generation or the like occurs, and thus, the cyclic performance may be degraded. Since the number of pores increases as PD decreases, the threshold value of TA increases. As described above, since there is a negative correlation between PD and TA, a is a negative value. It is more preferable that b used in Expression (1) is 8≤b≤10.6.

The electrode according to the embodiment can be used as a positive electrode or a negative electrode, and it is preferable that the electrode is used as the negative electrode.

Hereinafter, the details of the electrode according to the embodiment will be described.

The electrode may include an active material-containing layer and a current collector. The active material-containing layer is supported on at least one surface of the current collector. The active material-containing layer may be supported on one surface of the current collector, or may be supported on both surfaces. The active material-containing layer may further contain granular carbons and a binder, in addition to the active material and the fiber carbon.

The active material contains a titanium-containing composite oxide. It is preferable that the titanium-containing composite oxide includes at least one compound represented by a general formula selected from the group consisting of AₓTiM_{y}Nb_{2-y}O_{7±z}(0≤x≤5, 0≤y≤0.5, −0.3≤z≤0.3, M is at least one metal element other than Ti and Nb, A is at least one of Li and Na), Li₂₊ₐNa₂Ti₆O₁₄ (0≤a≤6), and LiₓTiO₂ (0≤x≤1).

The titanium-containing composite oxide may include at least one compound selected from the group consisting of lithium titanate having a ramsdellite structure (for example, Li_{2+y}Ti₃O₇, 0≤y≤3), lithium titanate having a spinel structure (for example, Li₄₊ₓTi₅O₁₂, 0≤x≤3), monoclinic titanium dioxide (TiO₂), anatase-type titanium dioxide, rutile-type titanium dioxide, a hollandite-type titanium composite oxide, an orthorhombic titanium composite oxide, and a monoclinic niobium-titanium composite oxide.

Examples of the orthorhombic titanium-containing composite oxide include a compound represented by Li₂₊ₐM(I)_{2-b}Ti_{6-c}M(II)dO_{14+σ}. Here, M(I) is at least one selected from the group consisting of Sr, Ba, Ca, Mg, Na, Cs, Rb, and K. M(II) is at least one selected from the group consisting of Zr, Sn, V, Nb, Ta, Mo, W, Y, Fe, Co, Cr, Mn, Ni, and Al. Each subscript in the composition formula is 0≤a≤6, 0≤b<2, 0≤c<6, 0≤d<6, and −0.5≤σ≤0.5. Specific examples of the orthorhombic titanium-containing composite oxide include Li₂₊ₐNa₂Ti₆O₁₄ (0≤a≤6).

Examples of the monoclinic niobium titanium composite oxide include a compound represented by LiₓTi_{1-y}M1_{y}Nb_{2-z}M2_{z}O_{7+δ}. Here, M1 is at least one selected from the group consisting of Zr, Si, and Sn. M2 is at least one selected from the group consisting of V, Ta, and Bi. Each subscript in the composition formula is 0≤x≤5, 0≤y<1, 0≤z<2, and −0.3≤δ≤0.3. Specific examples of the monoclinic niobium titanium composite oxide include LiₓNb₂TiO₇ (0≤x≤5), and other examples of the monoclinic niobium titanium composite oxide include a compound represented by LiₓTi_{1-y}M3_{y+z}Nb_{2-z}O_{7-δ}. Here, M3 is at least one selected from Mg, Fe, Ni, Co, W, Ta, and Mo. Each subscript in the composition formula is 0≤x<5, 0≤y<1, 0≤z<2, and −0.3≤δ≤0.3.

The carbon fiber and the granular carbon are blended as a conductive agent for improving current collection performance and suppressing contact resistance between the active material and the current collector.

The carbon fiber is a fiber-shaped carbon in which a ratio Li/Si of a length Li in a longitudinal direction to the diameter of the sectional surface perpendicular to the longitudinal direction, that is, a thickness Si is 50 or more. It is preferable that the ratio Li/Si is 150 or more and 10000 or less. It is preferable that the diameter of the sectional surface of the carbon fiber perpendicular to the longitudinal direction, that is, the thickness is 1 nm or more and 200 nm or less (0.001 μm or more and 0.2 μm or less). It is preferable that the length of the carbon fiber is 5 μm or more and 50 μm or less. Examples of the carbon fiber include a vapor grown carbon fiber (VGCF). Examples of the vapor grown carbon fiber include a carbon nanotube (CNT) and a carbon nanofiber (CNF). One of them may be used as the carbon fiber, or a combination of two or more thereof may be used as the carbon fiber.

In the active material-containing layer, a blending amount of the carbon fiber with respect to 100 parts by mass of the active material is preferably 0.01 parts by mass or more and 10 parts by mass or less, and more preferably 0.1 parts by mass or more and 5 parts by mass or less. In a case where the amount of carbon fiber is large, it is possible to improve the electronic conductivity of the active material-containing layer. On the other hand, in a case where the amount of carbon fiber is excessively large, there is a concern that the energy density decreases.

The granular carbon is a granular carbon in which a ratio L2/S2 of a length L2 of a major axis to a length S2 of a minor axis is less than 50. The granular carbon also includes a scale-shaped carbon. Examples of the granular carbon include carbon black such as acetylene black and a carbonaceous material such as graphite. One of them may be used as the granular carbon, or a combination of two or more thereof may be used as the granular carbon.

In the active material-containing layer, a blending amount of the granular carbon with respect to 100 parts by mass of the active material is preferably 0 parts by mass or more and 10 parts by mass or less, and more preferably 1 part by mass or more and 5 parts by mass or less. In a case where the amount of granular carbon is large, it is possible to improve the electronic conductivity of the active material-containing layer. On the other hand, in a case where the amount of granular carbon is excessively large, there is a concern that the energy density decreases.

The binder is blended to fill a gap between the dispersed active materials and bind the active material and a negative electrode current collector. Examples of the binder include polytetrafluoro ethylene (PTFE), polyvinylidene fluoride (PVdF), fluorine-based rubber, styrene butadiene rubber, a polyacrylic acid compound, an imide compound, carboxymethyl cellulose (CMC), and a salt of CMC. One of them may be used as the binder, or a combination of two or more thereof may be used as the binder.

In the active material-containing layer, a blending amount of the binder with respect to the active material of 100 parts by mass is preferably 0 parts by mass or more and 10 parts by mass or less, and more preferably 1 part by mass or more and 5 parts by mass or less. In a case where the amount of binder is large, there are sufficient binding properties between the active material-containing layer and the current collector, and excellent cyclic performance can be expected. On the other hand, in a case where the amount of binder us excessively large, there is a concern that the energy density decreases.

As the current collector, a material that is electrochemically stable at a potential at which lithium (Li) is inserted to and extracted from the active material is used. For example, it is preferable that the current collector is made of copper, nickel, stainless steel, or aluminum, or an aluminum alloy containing one or more elements selected from Mg, Ti, Zn, Mn, Fe, Cu, and Si. A thickness of the current collector is preferably 5 μm or more and 20 μm or less. A current collector having such a thickness can balance the strength of the electrode and weight reduction.

In addition, the current collector may include a portion in which the active material-containing layer is not formed on the surface. The portion can serve as a current collector tab.

The density of the active material-containing layer is preferably 2.3 g/cm³ or more and 3 g/cm³ or less, and more preferably 2.5 g/cm³ or more and 2.8 g/cm³ or less.

Next, a method for producing the electrode according to the embodiment will be described.

First, the carbon fiber, a binding material, and pure water were mixed and stirred with a planetary mixer. Here, the used binding material is a first binding material. As a solvent, for example, N-methyl-2-pyrrolidone or the like may be used, instead of the pure water. The stirring speed, for example, is 10 rpm or more and 60 rpm or less, and the stirring time is 5 minutes or longer and 2 hours or shorter. After that, the active material and the granular carbon are added to the mixture, and are further stirred with the planetary mixer. When stirring, the stirring speed was 40 rpm, and the stirring time was 30 minutes. Further, a stirring treatment was performed with a bead mill. By further performing the stirring treatment with the bead mill, the dispersibility of the mixture is improved. As the bead mill, for example, a continuous-type horizontal Ready Mill RMH-03, manufactured by AIMEX CO., is used. The flow rate of the bead mill, for example, is 10 mL/min or more and 50 mL/min or less. The rotation rate of the bead mill is 500 rpm or more and 2500 rpm or less. After that, a second binding material was added and stirred with the planetary mixer to prepare dispersed slurry.

Next, the dispersed slurry was applied to one surface or both surfaces of the current collector, and the coated film was dried to obtain a stacked body of the active material-containing layer and the current collector. By performing a press treatment with respect to the stacked body, it is possible to obtain the electrode.

The electrode according to the first embodiment described above includes the active material-containing layer containing the active material and the carbon fiber, and in the logarithmic differential pore volume distribution curve of the active material-containing layer by mercury porosimetry, the pore diameter PD at the peak indicating the maximum logarithmic differential pore volume is greater than 0.1 μm and 0.3 μm or less. The full width at half height of the peak is 0.1 μm or less. By using such an electrode, it is possible to attain the secondary battery excellent in the cyclic performance even in a high-temperature environment of 60° C. or higher. Such a secondary battery is excellent in the cyclic performance, in particular, in a high-temperature environment of 70° C. or higher. The upper limit of the usage environment assumed as high temperature is, for example, 80° C., but is not limited to this.

According to the embodiment, an electrode and a secondary battery, which are excellent in high-temperature cyclic performance can be obtained.

### Second Embodiment

According to a second embodiment, a secondary battery including a negative electrode, a positive electrode, and an electrolyte is provided. At least one of the negative electrode and the positive electrode is the electrode according to the first embodiment. In a case where either the negative electrode or the positive electrode is the electrode according to the first embodiment, a counter electrode may have a configuration different from that in the first embodiment.

The secondary battery according to the second embodiment may further include a separator between the positive electrode and the negative electrode. The negative electrode, the positive electrode, and the separator may configure an electrode group. The electrolyte can be retained in the electrode group.

In addition, the secondary battery according to the second embodiment may further include an exterior package member housing the electrode group and the electrolyte.

The secondary battery according to the second embodiment can further include a negative electrode terminal electrically connected to the negative electrode and a positive electrode terminal electrically connected to the positive electrode.

The secondary battery according to the second embodiment may be, for example, a lithium ion secondary battery. In addition, the secondary battery includes a non-aqueous electrolyte secondary battery containing a non-aqueous electrolyte.

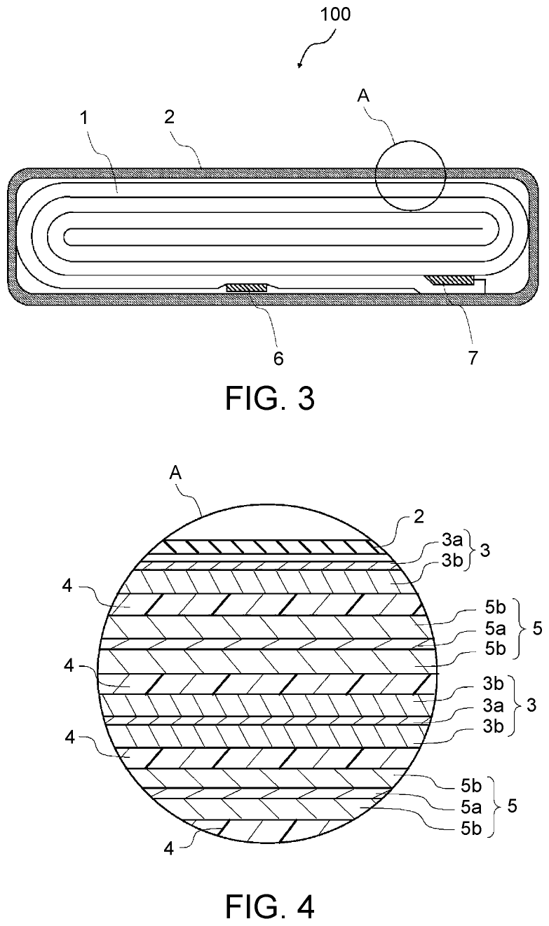

FIG. 3 is a sectional view schematically illustrating an example of the secondary battery according to the second embodiment. FIG. 4 is a sectional view in which a part A of the secondary battery illustrated in FIG. 3 is enlarged.

A secondary battery 100 illustrated in FIG. 3 and FIG. 4 includes a bag-shaped exterior package member 2 illustrated in FIG. 3 and FIG. 4, an electrode group 1 illustrated in FIG. 3, and an electrolyte which is not illustrated. The electrode group 1 and the electrolyte are housed in the bag-shaped exterior package member 2. The electrolyte (not illustrated) is retained in the electrode group 1.

The bag-shaped exterior package member 2 includes a laminate film in which a metal layer is interposed between two resin layers.

As illustrated in FIG. 3, the electrode group 1 is a flat and wound-type electrode group. The electrode group 1 that is flat and wound, as illustrated in FIG. 4, includes a negative electrode 3, a separator 4, and a positive electrode 5. The separator 4 is interposed between the negative electrode 3 and the positive electrode 5.

The negative electrode 3 includes a negative electrode current collector 3a and a negative electrode active material-containing layer 3b. In a portion of the negative electrode 3 positioned on the outermost shell of the wound-type electrode group 1, as illustrated in FIG. 4, the negative electrode active material-containing layer 3b is formed only on the inner surface side of the negative electrode current collector 3a. In other portions of the negative electrode 3, the negative electrode active material-containing layer 3b is formed on both surfaces of the negative electrode current collector 3a.

The positive electrode 5 includes a positive electrode current collector 5a, and a positive electrode active material-containing layer 5b formed on both surfaces of the positive electrode current collector.

As illustrated in FIG. 3, a negative electrode terminal 6 and a positive electrode terminal 7 are positioned in the vicinity of the outer circumferential end of the wound-type electrode group 1. The negative electrode terminal 6 is connected to a portion positioned on the outermost shell of the negative electrode current collector 3a. In addition, the positive electrode terminal 7 is connected to a portion positioned on the outermost shell of the positive electrode current collector 5a. Such negative electrode terminal 6 and positive electrode terminal 7 extend to the outside from an opening portion of the bag-shaped exterior package member 2. A thermoplastic resin layer is provided on the inner surface of the bag-shaped exterior package member 2, and the opening portion is sealed by the thermal fusion of the thermoplastic resin layer.

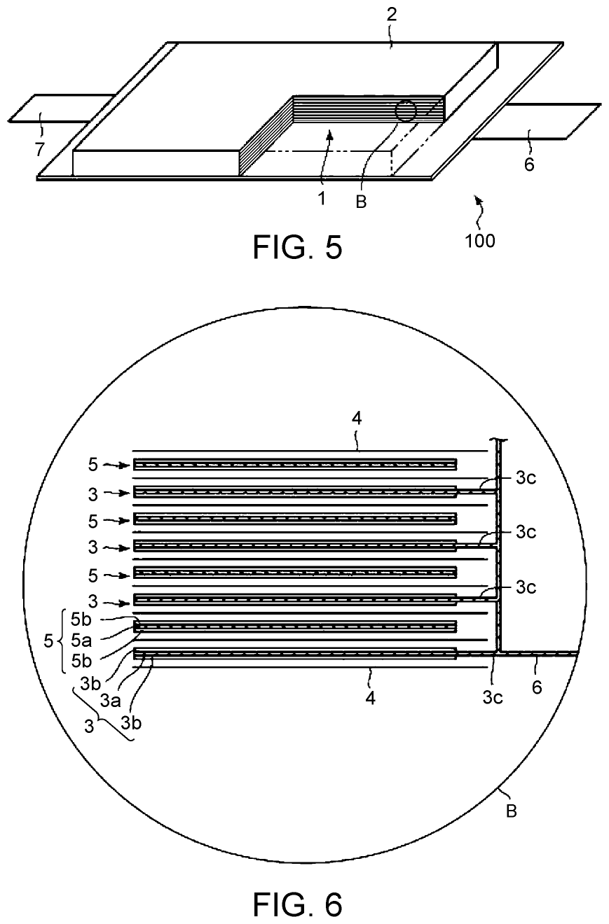

The secondary battery according to the second embodiment is not limited to the secondary battery having a configuration illustrated in FIG. 3 and FIG. 4, and for example, may be a battery having a configuration illustrated in FIG. 5 and FIG. 6.

FIG. 5 is a partial cutout perspective view schematically illustrating another example of the secondary battery according to the second embodiment. FIG. 6 is a sectional view in which a part B of the secondary battery illustrated in FIG. 5 is enlarged.

The secondary battery 100 illustrated in FIG. 5 and FIG. 6 includes the electrode group 1 illustrated in FIG. 5 and FIG. 6, the exterior package member 2 illustrated in FIG. 5, and the electrolyte which is not illustrated. The electrode group 1 and the electrolyte are housed in the exterior package member 2. The electrolyte is retained in the electrode group 1.

The exterior package member 2 includes a laminate film in which a metal layer is interposed between two resin layers.

The electrode group 1, as illustrated in FIG. 6, is a stacked electrode group. The stacked electrode group 1 has a structure in which the negative electrode 3 and the positive electrode 5 are alternately stacked while interposing the separator 4 therebetween.

The electrode group 1 includes a plurality of negative electrodes 3. Each of the plurality of negative electrodes 3 includes the negative electrode current collector 3a, and the negative electrode active material-containing layer 3b supported on both surfaces of the negative electrode current collector 3a. The electrode group 1 includes a plurality of the positive electrodes 5. Each of the plurality of the positive electrodes 5 includes a positive electrode current collector 5a and positive electrode active material-containing layers 5b supported on both surfaces of the positive electrode current collector 5a.

The negative electrode current collector 3a of each of the negative electrodes 3 includes a portion 3c in which the negative electrode active material-containing layer 3b is not supported even on any surface, on one side. The portion 3c serves as a negative electrode current collector tab. As illustrated in FIG. 6, the portion 3c serving as a negative electrode current collector tab does not overlap the positive electrode 5. A plurality of the negative electrode current collector tabs (portions 3c) is electrically connected to the negative electrode terminal 6 having a belt shape. A leading end of the negative electrode terminal 6 having a belt shape is drawn to the outside from the exterior package member 2.

Although not illustrated, the positive electrode current collector 5a of each positive electrode 5 includes, at its one side, a portion where the positive electrode active material-containing layer 5b is not supported on any surface. The portion serves as a positive electrode current collector tab. The positive electrode current collector tab does not overlap the negative electrode 3 similarly to the negative electrode current collector tab (portion 3c). The positive electrode current collector tab is located on an opposite side of the electrode group 1 with respect to the negative electrode current collector tab (portion 3c). The positive electrode current collector tab is electrically connected to the positive electrode terminal 7 having a belt shape. A leading end of the positive electrode terminal 7 having a belt shape is located on a side opposite to the negative electrode terminal 6 and is drawn to the outside of the exterior package member 2.

Hereinafter, the counter electrode, the electrolyte, the separator, the exterior package member, the negative electrode terminal, and the positive electrode terminal will be described in detail.

### 1) Counter Electrode

The counter electrode may include the active material-containing layer and the current collector. The active material-containing layer may be supported on one surface of the current collector, or may be supported on both surfaces. The active material-containing layer may contain the active material, the conductive agent, and the binder. The active material-containing layer may contain or may not contain the fiber carbon. The counter electrode is a negative electrode in a case where the electrode according to the embodiment is a positive electrode, and is a positive electrode in a case where the electrode according to the embodiment is a negative electrode. It is preferable that the counter electrode is the positive electrode. Here, the description will be made on the presumption that the counter electrode is the positive electrode.

As the positive electrode active material, for example, an oxide or a sulfide can be used. The positive electrode may contain one type of compound alone, or may contain two or more types of compounds in combination, as the positive electrode active material. Examples of the oxide and the sulfide include a compound that is capable of inserting and extracting Li or a Li ion.

Examples of such a compound include manganese dioxide (MnO₂), iron oxide, copper oxide, nickel oxide, lithium-manganese composite oxide (for example, LiₓMn₂O₄ or LiₓMnO₂; 0<x≤1), a lithium-nickel composite oxide (for example, LiₓNiO₂; 0<x≤1), a lithium-cobalt composite oxide (for example, LiₓCoO₂; 0<x≤1), a lithium-nickel-cobalt composite oxide (for example, LiₓNi_{1-y}Co_{y}O₂; 0<x≤1, 0<y<1), a lithium-manganese-cobalt composite oxide (for example LiₓMn_{y}Co_{1-y}O₂; 0<x≤1, 0<y<1), a lithium-manganese-nickel composite oxide having a spinel structure (for example, LiₓMn_{2-y}Ni_{y}O₄; 0<x≤1, 0<y<2), a lithium-phosphorus oxide having an olivine structure (for example, LiₓFePO₄; 0<x≤1, LiₓFe_{1-y}Mn_{y}PO₄; 0<x≤1, 0<y<1, LiₓCoPO₄; 0<x≤1), iron sulfate (Fe₂ (SO₄)₃), vanadium oxide (for example, V₂O₅), and a lithium-nickel-cobalt-manganese composite oxide (LiₓNi_{1-y-z}Co_{y}Mn_{z}O₂; 0<x≤1, 0<y<1, 0<z<1, y+z<1).

Among them, examples of the compound that is more preferable as the positive electrode active material include a lithium-manganese composite oxide having a spinel structure (for example, LiₓMn₂O₄; 0<x≤1), a lithium-nickel composite oxide (for example LiₓNiO₂; 0<x≤1), a lithium-cobalt composite oxide (for example, LiₓCoO₂; 0<x≤1), a lithium-nickel-cobalt composite oxide (for example, LiₓNi_{1-y} Co_{y}O₂; 0<x≤1, 0<y<1), a lithium-manganese-nickel composite oxide having a spinel structure (for example, LiₓMn_{2-y}Ni_{y}O₄; 0<x≤1, 0<y<2), a lithium-manganese-cobalt composite oxide (for example, LiₓMn_{y}Co_{1-y}O₂; 0<x≤1, 0<y<1), lithium iron phosphate (for example, LiₓFePO₄; 0<x≤1), and a lithium-nickel-cobalt-manganese composite oxide (LiₓNi_{1-y-z}Co_{y}Mn_{z}2; 0<x≤1, 0<y<1, 0<z<1, y+z<1). By using such compounds in the positive electrode active material, it is possible to increase a positive electrode potential.

In a case where a room-temperature molten salt is used as the electrolyte of the battery, it is preferable to use a positive electrode active material containing lithium iron phosphate, LiₓVPO₄F (0≤x≤1), a lithium manganese composite oxide, a lithium-nickel composite oxide, a lithium-nickel-cobalt composite oxide, or a mixture thereof. Since such compounds have low reactivity with the room-temperature molten salt, it is possible to improve cycle life. The details of the room-temperature molten salt will be described below.

It is preferable that the primary particle diameter of the positive electrode active material is 100 nm or more and 1 μm or less. The positive electrode active material with a primary particle diameter of 100 nm or more is easy to handle in industrial production. The positive electrode active material with a primary particle diameter of 1 μm or less is capable of smoothly diffusing lithium ions in a solid.

It is preferable that the specific surface area of the positive electrode active material is 0.1 m²/g or more and 10 m²/g or less. The positive electrode active material with a specific surface area of 0.1 m²/g or more is capable of sufficiently ensuring an insertion/extraction site of a Li ion. The positive electrode active material with a specific surface area of 10 m²/g or less is easy to handle in the industrial production, and is capable of ensuring excellent charge and discharge cyclic performance.

The binder is blended to fill a gap between the dispersed positive electrode active materials and bind the positive electrode active material and the positive electrode current collector. Examples of the binder include polytetrafluoro ethylene (PTFE), polyvinylidene fluoride (PVdF), fluorine-based rubber, a polyacrylic acid compound, an imide compound, carboxy methyl cellulose (CMC), and a salt of CMC. One of them may be used as the binder, or a combination of two or more thereof may be used as the binder.

The conductive agent is blended to improve the current collection performance and suppress the contact resistance between the positive electrode active material and the positive electrode current collector. Examples of the conductive agent include a vapor grown carbon fiber (VGCF), carbon black such as acetylene black, and a carbonaceous material such as graphite. One of them may be used as the conductive agent, or a combination of two or more thereof may be used as the conductive agent. In addition, the conductive agent can also be omitted.

In the positive electrode active material-containing layer, it is preferable that each of the positive electrode active material and the binder is blended at a ratio of 80 mass % or more and 98 mass % or less, and 2 mass % or more and 20 mass % or less.

By setting the amount of binder to 2 mass % or more, it is possible to obtain a sufficient electrode strength. In addition, the binder may function as an insulator. Therefore, in a case where the amount of binder is 20 mass % or less, the amount of insulator contained in the electrode decreases, and thus, it is possible to reduce internal resistance.

In the case of adding the conductive agent, it is preferable that each of the positive electrode active material, the binder, and the conductive agent is blended at a ratio of 77 mass % or more and 95 mass % or less, 2 mass % or more and 20 mass % or less, and 3 mass % or more and 15 mass % or less.

By setting the amount of conductive agent to 3 mass % or more, it is possible to obtain the effects described above. In addition, by setting the amount of conductive agent to 15 mass % or less, it is possible to reduce a ratio of the conductive agent in contact with the electrolyte. In a case where such a ratio is low, it is possible to reduce the decomposition of the electrolyte in high-temperature storage.

It is preferable that the positive electrode current collector is an aluminum foil, or an aluminum alloy foil containing one or more elements selected from Mg, Ti, Zn, Ni, Cr, Mn, Fe, Cu, and Si.

The thickness of the aluminum foil or the aluminum alloy foil is preferably 5 μm or more and 20 μm or less, and more preferably 15 μm or less. It is preferable that the purity of the aluminum foil is 99 mass % or more. It is preferable that the content of a transition metal such as iron, copper, nickel, and chromium, contained in the aluminum foil or the aluminum alloy foil, is 1 mass % or less.

In addition, the positive electrode current collector may include a portion in which the positive electrode active material-containing layer is not formed on the surface. The portion may serve as the positive electrode current collector tab.

The electrode, for example, can be prepared by the following method. First, the active material, the conductive agent, and the binder are suspended in the solvent to prepare slurry. The slurry is applied to one surface or both surfaces of the current collector. Next, the applied slurry is dried to obtain a stacked body of the active material-containing layer and the current collector. After that, the stacked body is pressed. As described above, the electrode is prepared. Alternatively, a mixture is obtained by mixing the active material, the conductive agent, and the binder. Next, the mixture is formed into the shape of a pellet. Next, by disposing such a pellet on the current collector, it is possible to obtain the electrode.

### 2) Electrolyte

As the electrolyte, for example, a liquid non-aqueous electrolyte or a gel non-aqueous electrolyte can be used. The liquid non-aqueous electrolyte is prepared by dissolving the electrolyte salt serving as a solute in an organic solvent. It is preferable that the concentration of the electrolyte salt is 0.5 mol/L or more and 2.5 mol/L or less.

Examples of the electrolyte salt include lithium salt such as lithium perchlorate (LiClO₄), lithium hexafluorophosphate (LiPF₆), lithium tetrafluoroborate (LiBF₄), lithium hexafluorophosphate (LiAsF₆), lithium trifluoromethanesulfonate (LiCF₃SO₃), and bistrifluoromethyl sulfonyl imide lithium (LiN(CF₃SO₂)₂), and a mixture thereof. As the electrolyte salt, an electrolyte salt that is difficult to oxidize even at a high potential is preferable, and LiPF₆ is the most preferable.

Examples of the organic solvent include cyclic carbonates such as propylene carbonate (PC), ethylene carbonate (EC), and vinylene carbonate (VC); linear carbonates such as diethyl carbonate (DEC), dimethyl carbonate (DMC), and methyl ethyl carbonate (MEC); cyclic ethers such as tetrahydrofuran (THF), 2-methyl tetrahydrofuran (2MeTHF), and dioxolane (DOX); linear ethers such as dimethoxy ethane (DME) and diethoxy ethane (DEE); and γ-butyrolactone (GBL), acetonitrile (AN), and sulfolane (SL). These organic solvents can be used alone or used as a mixed solvent.

The gel non-aqueous electrolyte is prepared by compounding a liquid non-aqueous electrolyte and a polymeric material. Examples of the polymeric material include polyvinylidene fluoride (PVdF), polyacrylonitrile (PAN), polyethylene oxide (PEO), or a mixture thereof.

Alternatively, as the non-aqueous electrolyte, other than the liquid non-aqueous electrolyte and the gel non-aqueous electrolyte, a room-temperature molten salt (ionic melt) containing lithium ions, a polymeric solid electrolyte, an inorganic solid electrolyte, or the like may be used.

The room-temperature molten salt (ionic melt) is a compound which may exist as a liquid at room temperature (15° C. or higher and 25° C. or lower) among organic salts consisting of the combination of an organic cation and anion. The room-temperature molten salt includes a room-temperature molten salt which exists alone as a liquid, a room-temperature molten salt which becomes a liquid by being mixed with an electrolyte salt, a room-temperature molten salt which becomes a liquid by being dissolved in an organic solvent, or a mixture thereof. Generally, a melting point of a room-temperature molten salt used for a secondary battery is 25° C. or lower. The organic cation generally has a quaternary ammonium frame.

The polymeric solid electrolyte is prepared by dissolving the electrolyte salt in a polymeric material and solidifying it.

3) Separator The separator is made of, for example, a porous film or a synthetic resin nonwoven fabric containing polyethylene (PE), polypropylene (PP), cellulose, or polyvinylidene fluoride (PVdF). From the viewpoint of safety, a porous film made of polyethylene or polypropylene is preferably used. These porous films can be melted at a certain temperature and block off the current.

### 4) Exterior Package Member

As the exterior package member, for example, a container made of a laminate film, or a metal container can be used.

The thickness of the laminate film, for example, is 0.5 mm or less, and preferably 0.2 mm or less.

As the laminate film, a multilayer film including a plurality of resin layers, and a metal layer interposed between the resin layers can be used. The resin layer, for example, contains polymeric material such as polypropylene (PP), polyethylene (PE), nylon, and polyethylene terephthalate (PET). It is preferable that the metal layer includes an aluminum foil or an aluminum alloy foil in order to reduce the weight. The laminate film is sealed by thermal fusion, and thus, can be molded into the shape of an exterior package member.

The thickness of the wall of the metal container, for example, is 1 mm or less, more preferably 0.5 mm or less, and even more preferably 0.2 mm or less.

The metal container, for example, is made of aluminum, an aluminum alloy, or the like. It is preferable that the aluminum alloy contains an element such as magnesium, zinc, or silicon. If the aluminum alloy contains a transition metal such as iron, copper, nickel, or chromium, the content thereof is preferably 100 ppm by mass or less.

The shape of the exterior package member is not particularly limited. The shape of the exterior package member, for example, may be a flat shape (a thin shape), a square shape, a cylindrical shape, a coin shape, a button shape, or the like. The exterior package member can be suitably selected in accordance with the size of the battery or the use of the battery.

### 5) Negative Electrode Terminal

The negative electrode terminal may be made of a material that is electrochemically stable at a Li insertion/extraction potential of the negative electrode active material described above and has conductivity. Specifically, examples of the material of the negative electrode terminal include copper, nickel, stainless steel, or aluminum, or an aluminum alloy containing at least one element selected from the group consisting of Mg, Ti, Zn, Mn, Fe, Cu, and Si. It is preferable to use aluminum or an aluminum alloy, as the material of the negative electrode terminal. It is preferable that the negative electrode terminal contains the same material as that of the negative electrode current collector, in order to reduce the contact resistance with the negative electrode current collector.

### 6) Positive Electrode Terminal

The positive electrode terminal may be made of a material that is electrically stable in a potential range (vs. Li/Li+) of 3 V or more and 4.5 V or less with respect to the oxidation-reduction potential of lithium and has conductivity. Examples of the material of the positive electrode terminal include aluminum, or an aluminum alloy containing at least one element selected from the group consisting of Mg, Ti, Zn, Mn, Fe, Cu, and Si. The positive electrode terminal is preferably formed of the same material as that for the positive electrode current collector in order to reduce the contact resistance with the positive electrode current collector.

Next, the secondary battery according to the second embodiment will be described in more detail, with reference to the drawings.

The secondary battery according to the second embodiment includes the electrode according to the first embodiment. Accordingly, the secondary battery according to the second embodiment is excellent in the high-temperature cyclic performance.

### Third Embodiment

According to a third embodiment, an assembled battery is provided. The assembled battery according to the third embodiment includes a plurality of secondary batteries according to the second embodiment. In the assembled battery according to the third embodiment, each single battery may be arranged by being electrically connected in series or in parallel, or may be arranged by being electrically connected in combination of series and parallel.

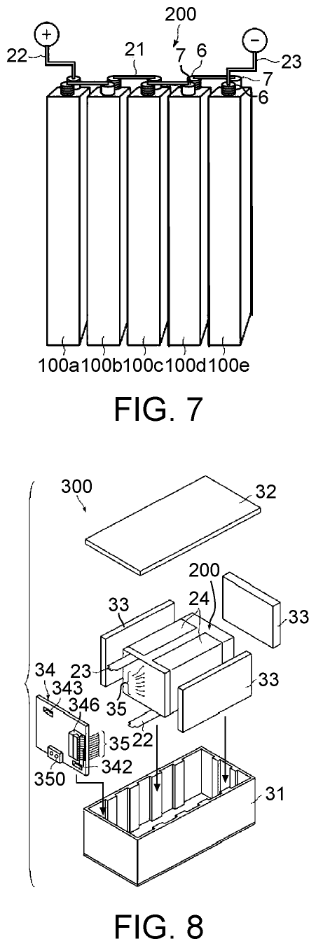

FIG. 7 is a perspective view schematically illustrating an example of the assembled battery according to the third embodiment. An assembled battery 200 illustrated in FIG. 7 includes five single batteries 100a to 100e, four bus bars 21, a positive electrode side lead 22, and a negative electrode side lead 23. Each of five single batteries 100a to 100e is the secondary battery according to the second embodiment.

The bus bar 21, for example, connects the negative electrode terminal 6 of one single battery 100a and the positive electrode terminal 7 of the adjacent single battery 100b. As described above, five single batteries 100 are connected in series by four bus bars 21. That is, the assembled battery 200 in FIG. 7 is a 5-series assembled battery. Although an example is not illustrated, in an assembled battery including a plurality of single batteries electrically connected in parallel, for example, a plurality of negative electrode terminals are connected to one another by bus bars and a plurality of positive electrode terminals are connected to one another by bus bars, so that the plurality of single batteries can be electrically connected.

The positive electrode terminal 7 of at least one battery among five single batteries 100a to 100e is electrically connected to the positive electrode side lead 22 for external connection. In addition, the negative electrode terminal 6 of at least one battery among five single batteries 100a to 100e is electrically connected to the negative electrode side lead 23 for external connection.

The assembled battery according to the third embodiment includes the secondary battery according to the second embodiment. Therefore, the assembled battery according to the third embodiment is excellent in the high-temperature cyclic performance.

### Fourth Embodiment

According to a fourth embodiment, a battery pack is provided. Such a battery pack includes the assembled battery according to the third embodiment. Such a battery pack may include a single secondary battery according to the second embodiment, instead of the assembled battery according to the third embodiment.

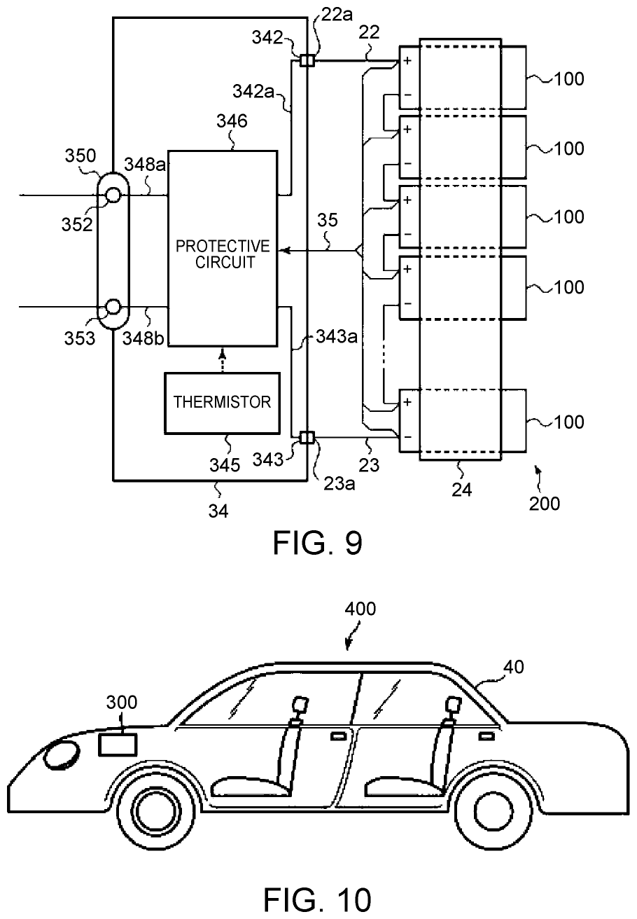

FIG. 8 is an exploded perspective view schematically illustrating an example of the battery pack according to the fourth embodiment. FIG. 9 is a block diagram illustrating an example of an electric circuit of the battery pack illustrated in FIG. 8. A battery pack 300 illustrated in FIG. 8 and FIG. 9 includes a housing container 31, a lid 32, a protective sheet 33, the assembled battery 200, a printed wiring board 34, a wire 35, and an insulating plate which is not illustrated.

The housing container 31 illustrated in FIG. 8 is a square bottomed container having a rectangular bottom surface. The housing container 31 is configured to be capable of housing the protective sheets 33, the assembled battery 200, the printed wiring board 34, and the wires 35. The lid 32 has a rectangular shape. The lid 32 covers the housing container 31 to house the assembled battery 200 and the like. The housing container 31 and the lid 32 are provided with opening portions, connection terminals, or the like (not illustrated) for connection to an external device or the like.

The assembled battery 200 includes a plurality of single batteries 100, a positive electrode side lead 22, a negative electrode side lead 23, and an adhesive tape 24.

At least one of the plurality of single batteries 100 is the secondary battery according to the second embodiment. Each of the plurality of single batteries 100 is electrically connected in series, as illustrated in FIG. 9. The plurality of single batteries 100 may be electrically connected in parallel or may be connected in a combination of series connection and parallel connection. When the plurality of single batteries 100 are connected in parallel, the battery capacity increases as compared to a case where the plurality of single batteries are connected in series.

The adhesive tape 24 fastens the plurality of single batteries 100. The plurality of single batteries 100 may be fixed using a heat-shrinkable tape instead of the adhesive tape 24. In this case, the protective sheets 33 are arranged on both side surfaces of the assembled battery 200, and the heat-shrinkable tape is wound around the assembled battery 200 and the protective sheets 33, and then the heat-shrinkable tape is shrunk by heating to bundle the plurality of single batteries 100.

One end of the positive electrode side lead 22 is connected to the assembled battery 200. One end of the positive electrode side lead 22 is electrically connected to the positive electrode of one or more single batteries 100. One end of the negative electrode side lead 23 is connected to the assembled battery 200. One end of the negative electrode side lead 23 is electrically connected to the negative electrode of one or more single batteries 100.

The printed wiring board 34 includes a positive electrode side connector 342, a negative electrode side connector 343, a thermistor 345, a protective circuit 346, wires 342a and 343a, an external power distribution terminal 350, a plus-side wire (positive side wire) 348a, and a minus-side wire (negative side wire) 348b. One main surface of the printed wiring board 34 faces one side surface of the assembled battery 200. An insulating plate (not illustrated) is disposed between the printed wiring board 34 and the assembled battery 200.

The other end 22a of the positive electrode side lead 22 is electrically connected to the positive electrode side connector 342. The other end 23a of the negative electrode side lead 23 is electrically connected to the negative electrode side connector 343.

The thermistor 345 is fixed to one main surface of the printed wiring board 34. The thermistor 345 detects the temperature of each single battery 100 and transmits detection signals to the protective circuit 346. The external power distribution terminal 350 is fixed to the other main surface of the printed wiring board 34. The external power distribution terminal 350 is electrically connected to a device that exists outside the battery pack 300. The external power distribution terminal 350 includes a positive side terminal 352 and a negative side terminal 353. The external power distribution terminal 350 outputs a current to the outside from the secondary battery and/or inputs a current to the secondary battery from the outside. In other words, when the battery pack is used as a power supply, the current is supplied to the outside via the external power distribution terminal. When the battery pack is charged, the charging current (including regenerative energy of motive force of an automobile or the like) is supplied to the battery pack via the external power distribution terminal.

The protective circuit 346 is fixed to the other main surface of the printed wiring board 34. The protective circuit 346 is connected to the positive side terminal 352 via the plus-side wire 348a. The protective circuit 346 is connected to the negative side terminal 353 via the minus-side wire 348b. The protective circuit 346 is electrically connected to the positive electrode side connector 342 via the wire 342a. The protective circuit 346 is electrically connected to the negative electrode side connector 343 via the wire 343a. The protective circuit 346 is electrically connected to each of the plurality of single batteries 100 via the wires 35. The protective sheets 33 are disposed on both inner surfaces of the housing container 31 along the long-side direction and on the inner surface along the short-side direction, facing the printed wiring board 34 across the assembled battery 200. The protective sheets 33 are made of, for example, a resin or rubber.

The protective circuit 346 controls charging and discharging of the plurality of single batteries 100. The protective circuit 346 is also configured to cut-off electric connection between the protective circuit 346 and the external power distribution terminal 350 (the positive side terminal 352 and the negative side terminal 353) to external devices, based on detection signals transmitted from the thermistor 345 or detection signals transmitted from each single battery 100 or the assembled battery 200. In the protective circuit 346, a circuit included in a device using the battery pack as a power source (for example, an electronic device, an automobile, and the like) may be used as the protective circuit of the battery pack.

As the detection signal transmitted from the thermistor 345, for example, a signal indicating that the temperature of the single battery 100 is detected to be a predetermined temperature or more. As the detection signal transmitted from each single battery 100 or the assembled battery 200, for example, a signal indicating detection of over-charge, over-discharge, and overcurrent of the single battery 100. When over-charge or the like is detected for each single battery 100, the battery voltage may be detected, or a positive electrode potential or a negative electrode potential may be detected. In the latter case, a lithium electrode to be used as a reference electrode is inserted into each single battery 100.

As the protective circuit 346, a circuit included in a device using the battery pack 300 as a power supply (for example, an electronic device, an automobile, or the like) may be used.

As described above, the battery pack 300 includes the external power distribution terminal 350. Therefore, the battery pack 300 can output current from the assembled battery 200 to an external device and input current from an external device to the assembled battery 200 via the external power distribution terminal 350. In other words, when the battery pack 300 is used as a power supply, the current from the assembled battery 200 is supplied to an external device via the external power distribution terminal 350. When the battery pack 300 is charged, the charging current from an external device is supplied to the battery pack 300 via the external power distribution terminal 350. When the battery pack 300 is used as an onboard battery, the regenerative energy of motive force of a vehicle can be used as the charging current from the external device.

The battery pack 300 may include a plurality of assembled batteries 200. In this case, the plurality of assembled batteries 200 may be connected in series, may be connected in parallel, or may be connected in a combination of series connection and parallel connection. The printed wiring board 34 and the wire 35 may be omitted. In this case, the positive electrode side lead 22 and the negative electrode side lead 23 may be used as the positive side terminal and the negative side terminal of the external power distribution terminal, respectively.

Such a battery pack, for example, is used in application required to have excellent cyclic performance when extracting a high current in a high-temperature environment. Specifically, such a battery pack, for example, is used as a stationary battery, or an in-vehicle battery of various vehicles. The battery pack is particularly suitably used as an onboard battery.

The battery pack according to the fourth embodiment includes the secondary battery according to the second embodiment or the assembled battery according to the third embodiment. Therefore, the battery pack according to the fourth embodiment is excellent in the high-temperature cyclic performance.

### Fifth Embodiment

According to a fifth embodiment, a vehicle is provided. Such a vehicle includes the battery pack according to the fourth embodiment. Examples of the vehicle according to the fifth embodiment include two- to four-wheeled hybrid electric automobiles, two- to four-wheeled electric automobiles, an electrically assisted bicycle, and a railway vehicle.

FIG. 10 is a partial transparent view schematically illustrating an example of the vehicle according to the embodiment. A vehicle 400 illustrated in FIG. 10 includes a vehicle body 40, and the battery pack 300 according to the fourth embodiment. In the example illustrated in FIG. 10, the vehicle 400 is a four-wheeled automobile. This vehicle 400 may include a plurality of battery packs 300 installed. In this case, batteries included in the battery pack 300 (for example, single batteries or assembled batteries) may be connected in series, may be connected in parallel, or may be connected in a combination of series connection and parallel connection.

In FIG. 10, an example is illustrated in which the battery pack 300 is mounted in an engine compartment positioned at the front of the vehicle body 40, but the mounting position of the battery pack 300 is not particularly limited. For example, in a case where the battery pack is mounted on an automobile, the battery pack can be mounted in the engine compartment of the vehicle body 40, in the rear part of the vehicle body, or under a seat.

The battery pack 300 can be used as a power supply of the vehicle 400. The battery pack 300 can also recover regenerative energy of motive force of the vehicle 400.

The vehicle according to the fifth embodiment may include a plurality of battery packs 300. In this case, the batteries of each of the battery packs 300 may be electrically connected in series, may be electrically connected in parallel, or may be electrically connected in combination of series and parallel. For example, in a case where each of the battery packs 300 includes the assembled battery, the assembled batteries may be electrically connected in series, may be electrically connected in parallel, or may be electrically connected in combination of series and parallel. Alternatively, in a case where each of the battery packs 300 includes the single battery, each of the batteries may be electrically connected in series, may be electrically connected in parallel, or may be electrically connected in combination of series and parallel.

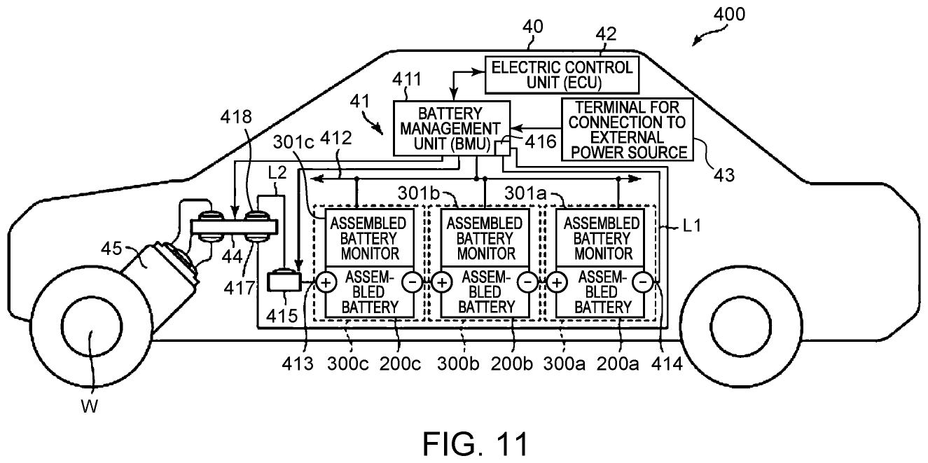

FIG. 11 is a diagram schematically illustrating an example of a control system relevant to an electric system in the vehicle according to the embodiment. The vehicle 400 illustrated in FIG. 11 is an electric automobile. The vehicle 400 includes the vehicle body 40, a vehicle power source 41, a vehicle electric control unit (ECU; electric control device) 42 that is a host control device of the vehicle power source 41, an external terminal (a terminal for connection to an external power source) 43, an inverter 44, and a driving motor 45. In the vehicle 400, the vehicle power source 41, for example, is mounted in the engine compartment, in the rear part of the vehicle body or under the seat of the automobile. Note that, in the vehicle 400 illustrated in FIG. 11, the mounting position of the vehicle power source 41 is schematically illustrated.

The vehicle power source 41 includes a plurality of (for example, three) battery packs 300a, 300b, and 300c, a battery management unit (BMU) 411, and a communication bus 412.

The battery pack 300a includes an assembled battery 200a and an assembled battery monitor 301a (for example, voltage temperature monitoring: VTM). The battery pack 300b includes an assembled battery 200b and an assembled battery monitor 301b. The battery pack 300c includes an assembled battery 200c and an assembled battery monitor 301c. The battery packs 300a to 300c are the same battery pack as the battery pack 300 described above, and the assembled batteries 200a to 200c are the same assembled battery as the assembled battery 200 described above. The assembled batteries 200a to 200c are electrically connected in series. Each of the battery packs 300a, 300b, and 300c can be independently removed or replaced with another battery pack 300.

Each of the assembled batteries 200a to 200c includes a plurality of single batteries connected in series. At least one of the plurality of single batteries is the secondary battery according to the second embodiment. Each of the assembled batteries 200a to 200c performs charge and discharge through a positive electrode terminal 413 and a negative electrode terminal 414.

The battery management unit 411 communicates with the assembled battery monitors 301a to 301c, and collects information relevant to a voltage, a temperature, and the like in each of the single batteries 100 included in the assembled batteries 200a to 200c of the vehicle power source 41. Accordingly, the battery management unit 411 collects information relevant to the maintenance of the vehicle power source 41.

The battery management unit 411 and the assembled battery monitors 301a to 301c are connected through the communication bus 412. In the communication bus 412, one set of communication lines is shared by a plurality of nodes (the battery management unit 411 and one or more assembled battery monitors 301a to 301c). The communication bus 412, for example, is a communication bus configured on the basis of a control area network (CAN) standard.

The assembled battery monitors 301a to 301c measure the voltage and the temperature of each of the single batteries configuring the assembled batteries 200a to 200c, on the basis of a command by the communication from the battery management unit 411. Here, the temperature can be measured only at several spots for one assembled battery, and the temperature of the entire single battery may be not measured.

The vehicle power source 41 may include an electromagnetic contactor (for example, a switch device 415 illustrated in FIG. 11) switching the presence or absence of electric connection between the positive electrode terminal 413 and the negative electrode terminal 414. The switch device 415 includes a precharge switch (not illustrated) that is turned on when the assembled batteries 200a to 200c are charged, and a main switch (not illustrated) that is turned on when the output from the assembled batteries 200a to 200c is supplied to a load. Each of the precharge switch and the main switch includes a relay circuit (not illustrated) switching ON and OFF in accordance with a signal supplied to a coil arranged in the vicinity of a switch element. The electromagnetic contactor such as the switch device 415 is controlled on the basis of a control signal from the vehicle ECU 42 controlling the entire operation of the battery management unit 411 or the vehicle 400.

The inverter 44 converts a direct-current voltage that is input into a high voltage of a three-phase alternate-current (AC) for driving a motor. A three-phase output terminal of the inverter 44 is connected to each three-phase input terminal of the driving motor 45. The inverter 44 is controlled on the basis of the control signal from the battery management unit 411 or the vehicle ECU 42 for controlling the entire operation of the vehicle. By controlling the inverter 44, an output voltage from the inverter 44 is adjusted.

The driving motor 45 is rotated by power supplied from the inverter 44. A driving force generated by the rotation of the driving motor 45, for example, is transmitted to an axle and a driving wheel W through a differential gear unit.

In the vehicle according to the fifth embodiment, the battery pack, for example, recovers the regenerative energy of the motive force of the vehicle. The vehicle may include a mechanism (a regenerator) converting the kinetic energy of the vehicle to the regenerative energy. A regenerative brake mechanism rotates the driving motor 45 when braking the vehicle 400, and converts the kinetic energy into the regenerative energy as electric energy. The regenerative energy recovered by the regenerative brake mechanism is input to the inverter 44, and is converted into a direct current. The converted direct current is input to the vehicle power source 41.

One terminal of a connection line Li is connected to the negative electrode terminal 414 of the vehicle power source 41. The other terminal of the connection line Li is connected to the negative electrode input terminal 417 of the inverter 44. In the connection line Li, a current detection unit (a current detection circuit) 416 in the battery management unit 411 is provided between the negative electrode terminal 414 and the negative electrode input terminal 417.

One terminal of a connection line L2 is connected to the positive electrode terminal 413 of the vehicle power source 41. The other terminal of the connection line L2 is connected to the positive electrode input terminal 418 of the inverter 44. In the connection line L2, the switch device 415 is provided between the positive electrode terminal 413 and the positive electrode input terminal 418.

The external terminal 43 is connected to the battery management unit 411. The external terminal 43, for example, can be connected to the external power source.

The vehicle ECU 42 cooperatively controls the vehicle power source 41, the switch device 415, the inverter 44, and the like, together with other management units and control devices including the battery management unit 411, in response to manipulation input of a driver or the like. By the cooperative control of the vehicle ECU 42 or the like, the output of the power from the vehicle power source 41, the charge of the vehicle power source 41, and the like are controlled, and the entire vehicle 400 is managed. Data relevant to the maintenance of the vehicle power source 41, such as the remaining capacity of the vehicle power source 41, is transmitted between the battery management unit 411 and the vehicle ECU 42 by the communication line.

The vehicle according to the fifth embodiment includes the battery pack according to the fourth embodiment installed. Therefore, the vehicle according to the fifth embodiment is excellent in a driving distance and driving performance.

### EXAMPLES

### Example 1

First, carbon fiber, a first binder, and pure water were mixed and stirred with a planetary mixer. As the carbon fiber, carbon nanotubes having an average thickness Si of 0.1 μm in the diameter of a sectional surface perpendicular to a longitudinal direction, that is, the thickness, and an average length Li of 20 μm was used. Hereinafter, the carbon fiber will be referred to as a first carbon fiber. An active material and granular carbon were added to the mixture of the carbon fiber, the first binder, and the pure water, and were stirred with the planetary mixer and a bead mill. When stirring, the stirring speed of the planetary mixer was 40 rpm, and the stirring time was 60 minutes. The flow rate of the bead mill was 30 mL/min, and the rotation speed was 2000 rpm. As the active material, niobium titanium composite oxide (Nb₂TiO₇) particles having an average particle diameter of 1 μm were used. Hereinafter, the active material will be referred to as NTO. As the granular carbon, acetylene black having an average particle diameter of 0.2 μm was used. Hereinafter, the granular carbon will be referred to as AB. After that, a second binding material was added and stirred with the planetary mixer to prepare dispersed slurry. When stirring, the stirring speed was 50 rpm, and the stirring time was 30 minutes. As the second binder, styrene butadiene rubber was used. Hereinafter, the binder will be referred to as SBR. As the first binder, carboxymethyl cellulose (CMC) was used.

In the dispersed slurry, the amount of carbon fiber, the amount of granular carbon, the amount of first binder, and the amount of second binder with respect to 100 parts by mass of the active material were 2 parts by mass, 2 parts by mass, 1 part by mass, and 1 part by mass, respectively.

Next, the dispersed slurry was applied to one surface or both surfaces of a current collector, and the coated film was dried to obtain a stacked body of an active material-containing layer and the current collector.

As the current collector, an aluminum alloy foil having a thickness of 12 μm was used. The stacked body was subjected to a press treatment to obtain an electrode. In the press treatment, the press treatment was implemented by adjusting the pressure to have a desired film density using a roll press machine. In this example, the press was performed such that the density of the active material-containing layer was 2.6 g/cm³.

### Example 2

The electrode was prepared by the same method as that in Example 1, except that the press condition was changed. The press was performed such that the density of the active material-containing layer was 2.7 g/cm³.

### Example 3

The electrode was prepared by the same method as that in Example 1, except that the press condition was changed. The press was performed such that the density of the active material-containing layer was 2.55 g/cm³.

### Example 4

The electrode was prepared by the same method as that in Example 1, except that the rotation speed of the bead mill was changed, and the press condition was changed. The rotation speed of the bead mill was 700 rpm. The press was performed such that the density of the active material-containing layer was 2.75 g/cm³.

### Example 5

The electrode was prepared by the same method as that in Example 1, except that the rotation speed of the bead mill was changed, and the press condition was changed. The rotation speed of the bead mill was 1200 rpm. The press was performed such that the density of the active material-containing layer was 2.55 g/cm³.

### Example 6

The electrode was prepared by the same method as that in Example 1, except that the blending amount of granular carbon AB was changed, and the rotation speed of the bead mill was changed. The rotation speed of the bead mill was 700 rpm. In the dispersed slurry, the amount of carbon fiber, the amount of granular carbon, the amount of first binder, and the amount of second binder with respect to 100 parts by mass of the active material were 2 parts by mass, 4 parts by mass, 1 part by mass, and 1 part by mass, respectively.

### Example 7

The electrode was prepared by the same method as that in Example 1, except that the blending amount of granular carbon AB was changed, the rotation speed of the bead mill was changed, and the press condition was changed. The rotation speed of the bead mill was 1200 rpm. The press was performed such that the density of the active material-containing layer was 2.75 g/cm³. In the dispersed slurry, the amount of carbon fiber, the amount of granular carbon, the amount of first binder, and the amount of second binder with respect to 100 parts by mass of the active material were 2 parts by mass, 4 parts by mass, 1 part by mass, and 1 part by mass, respectively.

### Example 8

The electrode was prepared by the same method as that in Example 1, except that the type of carbon fiber was changed, and the press condition was changed. As the carbon fiber, a carbon nanotube having an average thickness Si of 0.005 μm in the diameter of a sectional surface perpendicular to a longitudinal direction, that is, the thickness, and an average length Li of 50 μm used. Hereinafter, the carbon fiber will be referred to as a second carbon fiber. The press was performed such that the density of the active material-containing layer was 2.75 g/cm³.

### Example 9

The electrode was prepared by the same method as that in Example 8, except that the press condition was changed. The press was performed such that the density of the active material-containing layer was 2.8 g/cm³.

### Example 10

The electrode was prepared by the same method as that in Example 8, except that the rotation speed of the bead mill was changed, and the press condition was changed. The rotation speed of the bead mill was 1200 rpm. The press was performed such that the density of the active material-containing layer was 2.7 g/cm³.

### Example 11

The electrode was prepared by the same method as that in Example 8, except that the blending amount of granular carbon AB was changed, and the press condition was changed. The press was performed such that the density of the active material-containing layer was 2.6 g/cm³. In the dispersed slurry, the amount of carbon fiber, the amount of granular carbon, the amount of first binder, and the amount of second binder with respect to 100 parts by mass of the active material were 2 parts by mass, 1 part by mass, 1 part by mass, and 1 part by mass, respectively.

### Example 12

The electrode was prepared by the same method as that in Example 1, except that the type of active material was changed, the blending amount of granular carbon AB was changed, the rotation speed of the bead mill was changed, and the press condition was changed. As the active material, sodium-containing niobium titanium composite compound (Li₂Na_{1.5}Ti_{5.5}Nb_{0.5}O₁₄) particles having an average particle diameter of 5 μm were used. Hereinafter, the active material will be referred to as LNT. The rotation speed of the bead mill was 700 rpm. The press was performed such that the density of the active material-containing layer was 2.5 g/cm³. In the dispersed slurry, the amount of carbon fiber, the amount of granular carbon, the amount of first binder, and the amount of second binder with respect to 100 parts by mass of the active material were 2 parts by mass, 1 part by mass, 1 part by mass, and 1 part by mass, respectively.

### Example 13

The electrode was prepared by the same method as that in Example 1, except that the type of active material was changed, the type of carbon fiber was changed, the rotation speed of the bead mill was changed, and the press condition was changed. As the active material, LNT was used. As the carbon fiber, the second carbon fiber was used. The rotation speed of the bead mill was 1200 rpm. The press was performed such that the density of the active material-containing layer was 2.7 g/cm³.

### Example 14

The electrode was prepared by the same method as that in Example 1, except that the type of active material was changed, the blending amount of granular carbon AB was changed, the rotation speed of the bead mill was changed, and the press condition was changed. As the active material, titanium composite oxide (Li₄Ti₅O₁₂) particles having an average particle diameter of 3 μm were used. Hereinafter, the active material will be referred to as LTO. The rotation speed of the bead mill was 700 rpm. The press was performed such that the density of the active material-containing layer was 2.3 g/cm³. In the dispersed slurry, the amount of carbon fiber, the amount of granular carbon, the amount of first binder, and the amount of second binder with respect to 100 parts by mass of the active material were 2 parts by mass, 4 parts by mass, 1 part by mass, and 1 part by mass, respectively.

### Comparative Example 1

The electrode was prepared by the same method as that in Example 1, except that the blending amount of granular carbon AB was changed, and the press condition was changed. The press was performed such that the density of the active material-containing layer was 2.9 g/cm³. In the dispersed slurry, the amount of carbon fiber, the amount of granular carbon, the amount of first binder, and the amount of second binder with respect to 100 parts by mass of the active material were 2 parts by mass, 4 parts by mass, 1 part by mass, and 1 part by mass, respectively.

### Comparative Example 2

The electrode was prepared by the same method as that in Example 1, except that the number of carbon fibers was 0, the rotation speed of the bead mill was changed, and the press condition was changed. The rotation speed of the bead mill was 2200 rpm. The press was performed such that the density of the active material-containing layer was 2.8 g/cm³. In the dispersed slurry, the amount of carbon fiber, the amount of granular carbon, the amount of first binder, and the amount of second binder with respect to 100 parts by mass of the active material were 0 parts by mass, 2 parts by mass, 1 part by mass, and 1 part by mass, respectively.

### Comparative Example 3

The electrode was prepared by the same method as that in Example 1, except that the type of carbon fiber was changed, the blending amount of granular carbon AB was changed, the rotation speed of the bead mill was changed, and the press condition was changed. As the carbon fiber, the second carbon fiber was used. The rotation speed of the bead mill was 2200 rpm. The press was performed such that the density of the active material-containing layer was 2.8 g/cm³. In the dispersed slurry, the amount of carbon fiber, the amount of granular carbon, the amount of first binder, and the amount of second binder with respect to 100 parts by mass of the active material were 2 parts by mass, 4 parts by mass, 1 part by mass, and 1 part by mass, respectively.

### Comparative Example 4

The electrode was prepared by the same method as that in Example 1, except that the type of active material was changed, and the press condition was changed. As the active material, LNT was used. The press was performed such that the density of the active material-containing layer was 2.7 g/cm³.

### Comparative Example 5

The electrode was prepared by the same method as that in Example 1, except that the type of active material was changed, the type of carbon fiber was changed, the blending amount of granular carbon AB was changed, and the press condition was changed. As the active material, LTO was used. As the carbon fiber, the second carbon fiber was used. The press was performed such that the density of the active material-containing layer was 2.8 g/cm³. In the dispersed slurry, the amount of carbon fiber, the amount of granular carbon, the amount of first binder, and the amount of second binder with respect to 100 parts by mass of the active material were 2 parts by mass, 1 part by mass, 1 part by mass, and 1 part by mass, respectively.

### (Measurement of Logarithmic Differential Pore Volume Distribution Curve)

Logarithmic differential pore volume distribution curves of the electrodes prepared in Examples 1 to 14 and Comparative Examples 1 to 5 were measured by the method described above.

### (Evaluation of Cyclic Performance)

Cyclic performance was evaluated with a three-electrode glass cell. A battery was charged at a current density of 1 C in the environment of 70° C. until SOC reaches 100%. After that, the battery was discharged at a current density of 1 C until SOC becomes 0%, and the discharge capacity was measured. The charge and discharge was set to one cycle, and the charge and discharge was repeatedly performed until a discharge capacity maintenance rate with respect to the first discharge capacity becomes 80%. The results are shown in Table 3.

The production conditions of the electrodes according to Examples 1 to 14 and Comparative Examples 1 to 5 are summarized in Table 1 and Table 2.

TABLE 1

| | | Carbon Fiber | | | | | Granular Carbon | |
|---|---|---|---|---|---|---|---|---|
| | | | | | | Blending | | Blending |
| | Active Material | | Thickness | Length | | Amount | | Amount |
| | Composition | Type | S1 [μm] | L1 [μm] | L1/S1 | (parts by mass) | Type | (parts by mass) |
| Example 1 | Nb₂TiO₇ | First Carbon Fiber | 0.1 | 20 | 200 | 2 | AB | 2 |
| Example 2 | Nb₂TiO₇ | First Carbon Fiber | 0.1 | 20 | 200 | 2 | AB | 2 |
| Example 3 | Nb₂TiO₇ | First Carbon Fiber | 0.1 | 20 | 200 | 2 | AB | 2 |
| Example 4 | Nb₂TiO₇ | First Carbon Fiber | 0.1 | 20 | 200 | 2 | AB | 2 |
| Example 5 | Nb₂TiO₇ | First Carbon Fiber | 0.1 | 20 | 200 | 2 | AB | 2 |
| Example 6 | Nb₂TiO₇ | First Carbon Fiber | 0.1 | 20 | 200 | 2 | AB | 4 |
| Example 7 | Nb₂TiO₇ | First Carbon Fiber | 0.1 | 20 | 200 | 2 | AB | 4 |
| Example 8 | Nb₂TiO₇ | Second Carbon Fiber | 0.005 | 50 | 10000 | 2 | AB | 2 |
| Example 9 | Nb₂TiO₇ | Second Carbon Fiber | 0.005 | 50 | 10000 | 2 | AB | 2 |
| Example 10 | Nb₂TiO₇ | Second Carbon Fiber | 0.005 | 50 | 10000 | 2 | AB | 2 |
| Example 11 | Nb₂TiO₇ | Second Carbon Fiber | 0.005 | 50 | 10000 | 2 | AB | 1 |
| Example 12 | Li₂Na_{1.5}Ti_{5.5}Nb_{0.5}O₁₄ | First Carbon Fiber | 0.1 | 20 | 200 | 2 | AB | 1 |
| Example 13 | Li₂Na_{1.5}Ti_{5.5}Nb_{0.5}O₁₄ | Second Carbon Fiber | 0.005 | 50 | 10000 | 2 | AB | 2 |
| Example 14 | Li₄Ti₅O₁₂ | First Carbon Fiber | 0.1 | 20 | 200 | 2 | AB | 4 |
| Comparative Example 1 | Nb₂TiO₇ | First Carbon Fiber | 0.1 | 20 | 200 | 2 | AB | 4 |
| Comparative Example 2 | Nb₂TiO₇ | None | — | — | — | 0 | AB | 2 |
| Comparative Example 3 | Nb₂TiO₇ | Second Carbon Fiber | 0.005 | 50 | 10000 | 2 | AB | 4 |
| Comparative Example 4 | Li₂Na_{1.5}Ti_{5.5}Nb_{0.5}O₁₄ | First Carbon Fiber | 0.1 | 20 | 200 | 2 | AB | 2 |
| Comparative Example 5 | Li₄Ti₅O₁₂ | Second Carbon Fiber | 0.005 | 50 | 10000 | 2 | AB | 1 |

In Table 1, in the column below the section of “Active Material”, the composition of the active material is described in the column of “Composition”. In addition, in the column below the section of “Carbon Fiber”, the type of carbon fiber, the average thickness S, the average length L, a ratio of the average length L to the average thickness S, and the blending amount with respect to 100 parts by mass of the active material are described in the columns of “Type”, “Thickness S1”, “Length L1”, “L1/S1”, and “Blending Amount (parts by mass)”, respectively. In addition, in the column below the section of “Granular Carbon”, the type of granular carbon and the blending amount with respect to 100 parts by mass of the active material are described in the columns of “Type” and “Blending Amount”, respectively.

TABLE 2

| | Rotation | |
|---|---|---|
| | Speed | Density |
| | [rpm] | [g/m³] |
| Example 1 | 2000 | 2.6 |
| Example 2 | 2000 | 2.7 |
| Example 3 | 2000 | 2.55 |
| Example 4 | 700 | 2.75 |
| Example 5 | 1200 | 2.55 |
| Example 6 | 700 | 2.6 |
| Example 7 | 1200 | 2.75 |
| Example 8 | 2000 | 2.75 |
| Example 9 | 2000 | 2.8 |
| Example 10 | 1200 | 2.7 |
| Example 11 | 2000 | 2.6 |
| Example 12 | 700 | 2.5 |
| Example 13 | 1200 | 2.7 |
| Example 14 | 700 | 2.3 |
| Comparative Example 1 | 2000 | 2.9 |
| Comparative Example 2 | 2200 | 2.8 |
| Comparative Example 3 | 2200 | 2.8 |
| Comparative Example 4 | 2000 | 2.7 |
| Comparative Example 5 | 2000 | 2.8 |

In Table 2, the rotation speed of the bead mill when stirring the carbon fiber, the first binder, the pure water, the active material, and the granular carbon is described in the column of “Rotation Speed”. In addition, the density of the active material-containing layer when pressing the stacked body of the active material-containing layer and the current collector with the roll press machine is described in the column of “Density”.

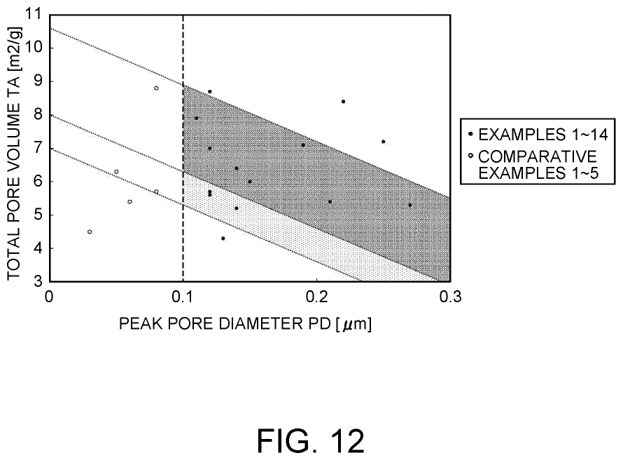

The performance of the electrodes according to Examples 1 to 14 and Comparative Examples 1 to 5, and the secondary batteries using the electrodes are summarized in Table 3 and FIG. 12.

TABLE 3

| | Electrode | | | | | |
|---|---|---|---|---|---|---|
| | Pore Surface | Peak Pore | Median | | Full Width | Secondary Battery |
| | Area TA | Diameter | Diameter | MD − PD | at Half | Cycle Number |
| | [m²/g] | PD [μm] | MD [μm] | [μm] | Height [μm] | Ratio (%) |
| Example 1 | 7 | 0.12 | 0.11 | −0.01 | 0.04 | 100 |
| Example 2 | 7.1 | 0.19 | 0.17 | −0.02 | 0.07 | 92.5 |
| Example 3 | 7.2 | 0.25 | 0.26 | 0.01 | 0.05 | 82.5 |
| Example 4 | 5.2 | 0.14 | 0.12 | −0.02 | 0.08 | 87.5 |
| Example 5 | 6 | 0.15 | 0.14 | −0.01 | 0.06 | 92.5 |
| Example 6 | 4.3 | 0.13 | 0.15 | 0.02 | 0.09 | 81.25 |
| Example 7 | 5.7 | 0.12 | 0.09 | −0.03 | 0.06 | 83.75 |
| Example 8 | 7.9 | 0.11 | 0.1 | −0.01 | 0.03 | 87.5 |
| Example 9 | 8.7 | 0.12 | 0.13 | 0.01 | 0.06 | 82.5 |
| Example 10 | 6.4 | 0.14 | 0.12 | −0.02 | 0.05 | 97.5 |
| Example 11 | 8.4 | 0.22 | 0.2 | −0.02 | 0.08 | 80 |
| Example 12 | 5.3 | 0.27 | 0.26 | −0.01 | 0.06 | 85 |
| Example 13 | 5.6 | 0.12 | 0.13 | 0.01 | 0.04 | 85 |
| Example 14 | 5.4 | 0.21 | 0.19 | −0.02 | 0.07 | 93.75 |
| Comparative Example 1 | 5.4 | 0.06 | 0.05 | −0.01 | 0.05 | 63.75 |
| Comparative Example 2 | 4.5 | 0.03 | 0.04 | 0.01 | 0.06 | 53.75 |
| Comparative Example 3 | 8.8 | 0.08 | 0.09 | −0.01 | 0.03 | 72.5 |
| Comparative Example 4 | 5.7 | 0.08 | 0.07 | −0.01 | 0.07 | 56.25 |
| Comparative Example 5 | 6.3 | 0.05 | 0.06 | 0.01 | 0.03 | 60 |

In Table 3, in the column below the section of “Electrode”, a total pore surface area TA of the electrode, a pore diameter PD of the peak, a median diameter MD, a value MD-PD obtained by subtracting the pore diameter PD of the peak from the median diameter MD, and the full width at half height of the peak, obtained by mercury porosimetry, are described in the columns of “Pore Surface Area TA”, “Peak Pore Diameter PD”, “Median Diameter MD”, “MD-PD”, and “Full Width at Half Height”, respectively. In addition, in the column below the section of “Battery”, a ratio of the cycle number of the secondary battery of each example or each comparative example to the cycle number of Example 1 is described in the column of “Cycle Number Ratio”. Here, the cycle number is a cycle number when the discharge capacity maintenance rate with respect to the discharge capacity of the first cycle becomes 80% in the condition of 70° C.

FIG. 12 is a graph illustrating a relationship between the peak pore diameter PD and the total pore volume TA. Plots relevant to Examples 1 to 15 are illustrated by a black circle, and plots relevant to Comparative Examples 1 to 5 are illustrated by a white circle. In addition, in the drawing, dotted lines corresponding to PD=0.1, TA=−17×PD+10.6 (in Expression (1), a=−17, b=10.6), TA=−17×PD+8 (in Expression (1), a=−17, b=8), and TA=−17×PD+7 (in Expression (1), a=−17, b=7) are drawn.

As it is obvious from the comparison between Examples 1 to 14 and Comparative Examples 1 to 5, the electrode plotted in a range where the pore diameter PD of the peak is greater than 0.1 μm and 0.3 μm or less is excellent in high-temperature cyclic performance, compared to the electrode not plotted in the range. Further, many of the electrodes plotted in a range surrounded by TA=−17×PD+10.6, TA=−17×PD+7, PD=0.1, and PD=0.3 (in FIG. 12, a light hatched portion and a dark hatched portion) have improved high-temperature cyclic performance, compared to the electrode not plotted in the range. Further, many of the electrodes plotted in a range surrounded by TA=−17×PD+10.6, TA=−17×PD+8, PD=0.1, and PD=0.3 (in FIG. 12, the dark hatched portion) have more improved high-temperature cyclic performance, compared to the electrode not plotted in the range.

The electrode according to at least one embodiment described above includes the active material-containing layer containing the active material and the carbon fiber, and in the logarithmic differential pore volume distribution curve of the active material-containing layer by mercury porosimetry, the pore diameter PD of the peak indicating the maximum logarithmic differential pore volume is greater than 0.1 μm and 0.3 μm or less, and the full width at half height of the peak is 0.06 μm or less. By using the electrode, it is possible to attain the secondary battery excellent in the high-temperature cyclic performance.

While certain embodiments of the present invention have been described, these embodiments have been presented by way of example only, and are not intended to limit the scope of the inventions. These novel embodiments can be embodied in a variety of other forms, various omissions, substitutions and changes in the form of the embodiments may be made without departing from the spirit of the inventions. The accompanying claims and their equivalents are intended to cover these embodiments or modifications thereof as would fall within the scope and spirit of the inventions.

What is claimed is:

1. An electrode comprising:
an active material-containing layer that includes an active material containing a titanium-containing composite oxide, and carbon fiber, wherein
the active material-containing layer has a peak indicating a maximum logarithmic differential pore volume, in a logarithmic differential pore volume distribution curve by mercury porositmetry, and
a pore diameter PD at the peak is greater than 0.1 μm and 0.3 μm or less.

2. The electrode according to claim 1, wherein a relationship between a total pore surface area TA of the active material-containing layer and the pore diameter PD of the peak by the mercury porosimetry is represented by the following equation (1):
$$TA = a \times PD + b , \qquad ( 1 )$$
wherein, a=−17, and 7≤b≤10.6.

3. The electrode according to claim 2, wherein the total pore surface area TA of the active material-containing layer by the mercury porosimetry is 4 m²/g or more.

4. The electrode according to claim 1, wherein a total pore volume TV of the active material-containing layer by the mercury porosimetry is 0.15 mL/g or less.

5. The electrode according to claim 1, wherein a value MD-PD obtained by subtracting the pore diameter PD of the peak from a median diameter MD of the active material-containing layer by the mercury porosimetry is −0.02 μm or more and 0.02 μm or less.

6. The electrode according to claim 1, wherein the titanium-containing composite oxide includes at least one compound represented by a general formula selected from the group consisting of AₓTiM_{y}Nb_{2-y}O_{7±z} (0≤x≤5, 0≤y≤0.5, −0.3≤z≤0.3, M is at least one metal element other than Ti and Nb, A is at least one of Li and Na), Li₂₊ₐNa₂Ti₆O₁₄ (0≤a≤6), and LiₓTiO₂ (0≤x≤1).

7. The electrode according to claim 1, wherein a diameter of a sectional surface of the carbon fiber perpendicular to a longitudinal direction is 1 nm or more and 200 nm or less.

8. The electrode according to claim 1, wherein a length of the carbon fiber is 5 μm or more and 50 μm or less.

9. A secondary battery, comprising:
a positive electrode;
a negative electrode; and
an electrolyte,
wherein at least one of the positive electrode and the negative electrode is the electrode according to claim 1.

10. A battery pack comprising the secondary battery according to claim 9.

11. The battery pack according to claim 10, further comprising:
an external terminal; and
a protective circuit.

12. The battery pack according to claim 10, comprising:
a plurality of the secondary batteries, wherein
the secondary batteries are electrically connected in series, in parallel, or in combination of series and parallel.

13. A vehicle comprising the battery pack according to claim 10.

14. The vehicle according to claim 13, comprising a mechanism converting kinetic energy of the vehicle to regenerative energy.
